(19) United States
(12) Patent Application Publication
(10) Pub. No.: US 2004/0117203 A1
(43) Pub. Date: Jun. 17, 2004

(54) Benefits qualification analysis and application method and computer readable code

(76) Inventor: Robert J. Brand, Philadelphia, PA (US)

Correspondence Address: SYNNESTVEDT & LECHNER, LLP, 2600 ARAMARK TOWER, 1101 MARKET STREET, PHILADELPHIA, PA, 191072950

(21) Appl. No.: 10/682,749

(22) Filed: Oct. 9, 2003

Related U.S. Application Data
(60) Provisional application No. 60/417,859, filed on Oct. 11, 2002.

(51) Int. Cl. G06F 17/60

(52) U.S. Cl. 705/1

(57) ABSTRACT

A method of making a plurality of social benefits available to potential recipients and computer readable code to effect the method are disclosed. The method is executed by providing a listing of the benefits and soliciting information relevant to the eligibility requirements, comparing the information with the requirements and predicting those benefits for which the recipient qualifies. The required information is obtained in distinct sets as general information needed by all benefit programs and information specific to a particular benefit program. Computer readable code effecting the method has an interview function that provides an interface with the users, a choice of languages for interaction and a benefits module that performs the data comparisons for each benefit program supported by the code.

### RELATED APPLICATION

This application is based on and claims the benefit of U.S. Provisional Application No. 60/417,859, filed Oct. 11, 2002.

### FIELD OF THE INVENTION

This invention concerns a method of applying for social benefits and especially such a method which may be effected via the Internet using computer readable code.

### BACKGROUND OF THE INVENTION

A vast array of social benefits are available to qualified citizens, resident aliens, foreign nationals and undocumented persons residing in the United States of America. Some of the benefits, such as the Earned Income Tax Credit (EIC), are administered by the Federal Government. Other benefits, such as the U.S. Department of Agriculture's Food Stamp Program or the Low Income Home Energy Assistance Program (LIHEAP), are federally funded but administered separately by each state of the United States. Still other benefits, such as the state earned income tax credit, are the responsibility of the state or county which provides the benefit. Yet another group of benefits, such as the Childrens' Health Insurance Program (CHIP), are publicly funded and privately administered. Further benefit programs are available which are privately funded and publicly administered, as well as privately funded and administered.

Thus, the Federal Government, the states, local communities, private philanthropies and employers have a substantially unique array of social benefit programs with unique eligibility requirements for receiving the benefits under each of the programs. Furthermore, due to the pronounced division of power between the various state governments and the United States Federal Government, even federally funded and mandated programs have different requirements as administered under general federal guidelines according to the laws of each state or county.

There is, thus, a bewildering array of social benefits available to qualified households through social programs which are divided for their administration and funding among combinations of the Federal Government, the state governments and private enterprise, each program with its own definitions of terms, eligibility requirements and durations for receiving benefits. The programs are generally need based and means tested to ensure that only those who are deserving and qualify for the benefits receive them. The application process is generally a product of the bureaucracy which administers the program and is often cumbersome and confusing. For those most in need, the process of applying for the benefits may be insurmountable. This may be due to poor or nonexistent English language skills within the household (oral as well as written), a lack of knowledge as to what programs are available, a lack of sophistication or experience at dealing with bureaucracies or a general mistrust of government and its police power.

There is clearly a need for a system which can aid those households most in need of social benefits by providing a catalog of the benefits available through state, federal and private programs enabling them to identify desired benefits, collecting the information required to apply for the desired benefits, analyzing the information for a particular household against the requirements for a particular benefit, predicting the amount and duration of the benefit for which the household qualifies and filling out the necessary forms or otherwise providing the information necessary to apply for the benefits to the proper administrative authorities in a form which is compatible with the requirements for receiving the benefits, including the rapid growth of electronic filing systems.

### SUMMARY OF THE INVENTION

The invention concerns a method of making a plurality of social benefits available to potential recipients. The method includes providing a listing of the plurality of social benefits, each of the social benefits having eligibility requirements. Information is solicited from the potential recipients related to the eligibility requirements for the social benefits, and this information is compared to the eligibility requirements for the social benefits allowing a prediction of those social benefits of the plurality of social benefits for which the potential recipients qualify. The method is preferably effected in a computer environment.

Once it is known which benefits the recipient qualifies for, applications may then be generated for that set of social benefits on behalf of the potential recipients. Application may then be made for the set of social benefits on behalf of the potential recipients, either through paper forms or by direct electronic means.

The information required to qualify for the various benefits may be solicited directly from the potential recipients on an individual basis or received on behalf of a group of potential recipients and processed serially. The information may be solicited or obtained directly from an organization with which the potential recipients are in some way affiliated.

The invention also concerns a method of obtaining a plurality of desired social benefits for a potential recipient from among a plurality of benefit programs. The method, preferably effected within a computer environment, comprises the steps of:

determining a subset of the benefit programs providing the desired social benefits;

obtaining a first information set describing the potential recipient, the first information set comprising information commonly required by all of the benefit programs of the set to apply for the benefits;

obtaining a plurality of second information sets describing the potential recipient, each one of the second information sets comprising information specifically required by a corresponding one of the benefit programs of the set to apply for benefits;

comparing information in the first information set with requirements to obtain the desired benefits from all of the benefit programs of the set;

comparing information in each of the second information sets with requirements from the corresponding benefit program of the set to obtain the desired benefits;

predicting the desired social benefits available from the set of benefits which the potential recipient is qualified to receive; and

applying for the desired social benefits for which the potential recipient is qualified.

Also included in the method is the step of following up with the beneficiary to ensure that the desired benefits are indeed secured. Further steps are designed to support effective use of new capabilities, such as linking the benefits programs with other institutions, such as banks.

Preferably, the methods according to the invention are effected by means of computer readable code stored on a media. The code collects and analyzes the data describing the qualifications of a potential recipient of benefits from a plurality of benefit programs. To that end, the code comprises a plurality of benefit program modules, each capable of collecting data from the potential recipient as is necessary to apply for a particular benefit. The code modules analyze the data against eligibility requirements for the particular benefit, calculate the degree of benefit for which the potential recipient qualifies and provide the information necessary to apply for the benefit.

The code preferably includes an interview module for facilitating communications between the potential recipient and the benefit program modules. The interview module may include a listing of the benefit programs supported by the code.

The interview module communicates with a number of language modules that provide a plurality of different languages for facilitating communication between the potential recipient and the code. A particular language is selectable from among the language modules by the potential recipient for interacting with the code.

The benefit program modules further comprise modules which collect data commonly required by a plurality of the benefit programs to apply for benefits as well as modules which collect data specifically required by one of the benefit programs and modules which are adapted to generate and transmit data to an authority administering a benefit program to formally apply for the social benefits.

### BRIEF DESCRIPTION OF THE DRAWINGS

FIG. 1 is a flow chart illustrating the steps of a method according to the invention and a system for effecting the method;

FIG. 2 is a flow chart illustrating the steps of another embodiment of a method according to the invention and another system for effecting the method; and

FIG. 3 is a chart illustrating the organization of a computer readable code embodying the invention.

### DETAILED DESCRIPTION

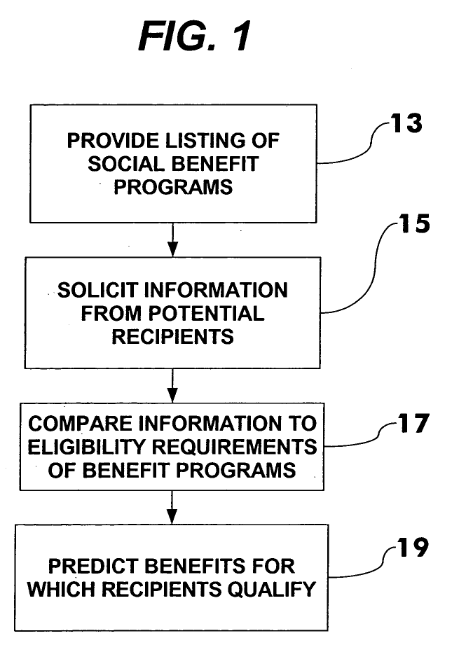

FIG. 1 is a flow chart illustrating steps of a method of making a plurality of social benefits available to potential recipients. The method is preferably effected in a computer environment using computer readable code stored on a media. The method includes the step of providing a listing of the plurality of social benefits, the step shown in box 13. Each of the social benefits has eligibility requirements which must be met by a recipient qualifying for the benefit or benefits. To that end, the method also includes the step of soliciting information from the potential recipients related to the eligibility requirements for the social benefits (box 15). In another step, the information is compared to the eligibility requirements for the social benefits (box 17), and a prediction is made identifying those social benefits of the plurality of social benefits for which the potential recipients qualify (box 19).

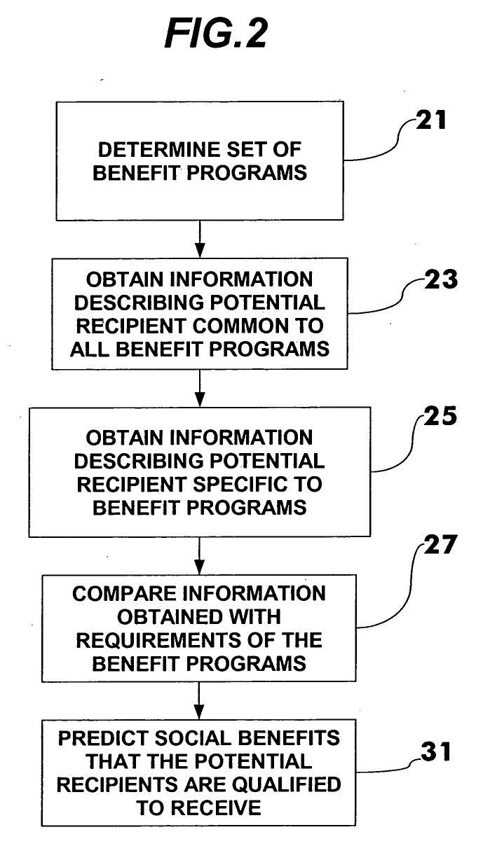

The flow chart shown in FIG. 2 illustrates steps of a method for obtaining a plurality of desired social benefits for a potential recipient from among a plurality of benefit programs. Box 21 represents the step of determining a set of benefit programs providing the desired social benefits. In box 23, a first information set describing the potential recipient is obtained. The first information set comprises information commonly required by all of the benefit programs of the set of benefits being applied for. In box 25, a plurality of second information sets describing the potential recipient are obtained. Each one of the second information sets comprises information specifically required by a corresponding one of the benefit programs. Box 27 represents the step of comparing information in the first information set with requirements to obtain the desired benefits from all of the benefit programs of said set, and box 29 represents comparing information in each of the second information sets with requirements from the corresponding benefit program of the set to obtain the desired benefits. In box 31, the step of predicting the desired social benefits that the potential recipient is qualified to receive is represented.

FIGS. 1 and 2 also illustrate a system configured to effect the steps of the methods according to the invention. To that end, each box may also be viewed as representing a means for effecting the steps listed in the box.

The methods according to the invention described herein are advantageously effected via a computer readable code in the form of an interactive “expert system”, which poses a series of questions to a potential recipient to elicit the required information to determine what benefits are desired, necessary routine information about the potential recipient and the particular qualifications of the potential recipient as they relate to one or more social benefit programs. The code then uses this information to compare the potential recipient's qualifications with the eligibility requirements of each benefit program of interest and predict those benefits for which the potential recipient may qualify. The code then arranges the information in the various formats required by the organizations and authorities administering the social programs of interest to formally apply for the benefits. The code may provide the information either electronically directly to the administering organization if such facilities are available, or produce completed paper applications which may be delivered to the administering organizations as a formal application for the benefits.

The method is intended to be used with over 70 currently known benefit programs, used for all 50 states of the United States and its possessions and be compatible with the requirements of every federal, state and private organization which administers a social benefit program. The size and scope of such a computer readable code suggest that it is advantageously resident on a server in communication with the internet and written in a computer language which is compatible with the World Wide Web. Having the code on the internet will provide for almost universal access and allow thousands of users simultaneous, realtime usage. Forms filled out by an expert system should also reduce the time and cost required to apply for benefits by eliminating errors.

FIG. 1 is a chart showing an embodiment of the organization of computer readable code 10 effecting a method of providing benefits according to the invention. The code 10 is accessed by various potential recipients 12, 14 over existing communication lines 16, preferably the Internet, via computer interface. Access may be effected via the potential recipient's own personal computer, a publically available computer, or from a computer network operated by an organization. Individuals who may not have the skills necessary to personally access the code can be provided with access by way of counselors or social workers trained to operate the program on behalf of a potential recipient.

Potential recipients may be a “household user” 12 of the code, which may represent an individual or a family or other grouping of people as defined by one or more of the benefit programs. Depending upon the particular benefit being sought, the various terms such as “family”, “relation”, “dependent” and the like will have different definitions, it is convenient to use the term “household user” to identify the potential recipients of the benefit program regardless of their actual number, relation or affiliation. An organization, such as a state, municipal or local department (for example, health and human services, division of motor vehicles, licensing and inspection), a non-profit organization, a private business or a corporation may also be a user (organizational user 14) and use the code on behalf of those potential recipients associated with the organization.

The code interacts with different users in different ways depending upon the needs and facilities available to user. For household users 12, web pages are preferably generated on the screen of the computer interface to communicate with the users. The web pages pose questions to the household user, who interacts with the code, either directly or through a counselor, by providing answers to the questions which are later used in the analysis of the benefit qualifications and the application for the benefits by other modules through queries to server-based databases and subsequent web pages generated in response to each query. Organizational users 14 will tend to interact more by transferring data from a computer system operated by the organization to the code, the code returning reports, either electronically or by hard copy, to the organization as described in detail below.

The code 10 is organized into a series of modules. The first module encountered by users is the INTERVIEW module 18. INTERVIEW module 18 identifies the user by type and then as an individual within its type so that it can direct operation of the code 10 appropriately depending upon the needs of the particular user.

For a household user 12, the INTERVIEW module 18 provides general information to the user describing the code, its purpose and use and may provide a catalog of the benefit programs supported by the code with descriptions of the programs. The INTERVIEW module 18 is linked to the LANGUAGE module 20 which allows the code to interact with the household user 12 in one of many languages of choice. Multiple languages are available through various sub-modules such as the ENGLISH sub-module 20a, and the SPANISH sub-module 20b. Language module “X” (20c) is representative of multiple additional languages intended to be within the capabilities of the code 10.

LANGUAGE module 20 communicates with the BENEFITS module 22. The BENEFITS module 22 is comprised of a plurality of sub-modules representing each benefit program supported by the code 10. For example, sub-module 22a, the FEDERAL TAXES module, permits a user to apply for Earned Income Tax Credit (EIC) benefit. The benefit is administered by the Federal Government through the Internal Revenue Service (IRS). Sub-module 22a communicates with a number of other modules such as the TAX 1 module 24, which collects and processes information from the user specific to the EIC benefit, and modules such as GLOBAL 1 (module 26) which collect and process information of a general nature such as the name, social security number, address and so forth of the user. Modules such as GLOBAL 1 provide their information to other benefit sub-modules such as the Childrens' Health Insurance Program sub-module 22b (CHIP), the FOOD STAMPS sub-module 22c, the Low Income Home Energy Assistance Program sub-module 22d (LIHEAP), as well as additional program benefit sub-modules represented by BENEFIT X, sub-module 22e. Additional benefit sub-modules may support prescription drug programs, medical service programs, a voter registration program to name but a few examples. The program benefit sub-modules 22 communicate with the user in a particular language determined by the user's choice via the LANGUAGE module 20 to solicit information required to qualify and apply for a particular benefit.

Once all of the global and program specific modules have collected the required data from the user, they analyze the user household's qualifications using known analysis techniques against the requirements of the program, for example, the EIC benefit. The FEDERAL TAXES module 22a communicates to the user the degree to which the household qualifies for the EIC benefit and then, at the discretion of the user, assembles the data necessary to apply for the benefit in the format required by the IRS. The application data is then communicated to the IRS, either through paper forms 28 via the mail or electronically through the communications lines 16 (preferably the Internet) by a communications module 30 (FEDERAL APPLICATION) to an IRS server 32.

Other program benefit modules 22 are organized similarly with the global modules soliciting data common to other programs and other modules handling data specific to a particular benefits program. When the benefit program is funded by the Federal Government but administered by the states, a state module 34 is used to collect and analyze the data required for applying for the benefit for a particular state. An example of this is provided in FIG. 1 for the FOOD STAMPS program benefits module 22c. The qualifications and benefits for food stamps are different for each state, and thus, there are state modules 34 for each state, such as 34a for Pennsylvania, 34b for New Jersey and 34c for the STATE X module which represents the other states. As shown, the state modules communicate with global modules such as modules 24 for collecting and analyzing common data and food stamp specific modules such as FSTAMP 1 (module 36). Once the required data is collected and analyzed, application is made for the benefit to the particular state through a state specific communications module such as PA STATE APPLICATION module 38, either by generating paper forms 40 or by communicating electronically through the communication line 16 with a Pennsylvania state government server 42.

An organizational user 14 may use the code 10 differently from a household user 12. The INTERVIEW module 18, upon identifying the organizational user, directs the code operation to the ORGANIZATION ACCOUNT module 44. The ORGANIZATION ACCOUNT module 44 is comprised of a plurality of organizational sub-modules, one for each organization accessing the code 10. Sub-modules shown by way of example include the SALVATION ARMY sub-module 44a, the HHS SUB-module 44b (Federal Department of Health and Human Services), and the ORG-X module 44c which represents a generic organization which accesses code 10.

Organizations may use code 10 to ascertain the eligibility of large lists of various individuals for various benefits in a “batch processing mode” wherein a computer operated by the organization communicates directly with the code through the INTERVIEW module 18 and the ORGANIZATION ACCOUNT module 44 by providing data from its databases to the BENEFITS module 22 for evaluation. The particular functions performed by the code on behalf of an organization are determined by the organizational sub-module associated with that organization. The code 10 accepts the data from the organization in whatever form is convenient to the organization and arranges is for use by the various modules of the code.

The data available to the code 10 also permits the organizational sub-modules to generate analysis reports useful, for example, for support of policy studies, to evaluate economic and societal trends, perform cost benefit analyses related to the performance of the code itself, as well as other activities requiring manipulation of input into or accessible to the code 10. An ORGANIZATION REPORT module 46 is accessed by the ORGANIZATION ACCOUNT MODULE 44 to prepare the desired reports and output them, either to paper copies 48 or back to the organization's computer system directly. The code provides the data or report in a format specified by the organization.

The code 10 further includes a GENERAL REPORT module 50 that can be used to generate reports such as internal diagnostics, evaluation of system metrics to assess system and user performance, provide manpower projections and performance evaluations for counseling services using the code, support policy studies and the like. The reports may be provided as paper copies 52 or supplied electronically to the operators of the code.

The method and computer readable code according to the invention comprise a system which provides expert advice and assistance to those most in need regarding how to apply for available social benefits. The method promises to simplify the collection of the required data and simplify and streamline the application process so that benefits are delivered more quickly and with fewer errors and at lower expense to those households in need.

The above-described steps can be implemented using standard well-known programming techniques. The novelty of the above-described embodiment lies not in the specific programming techniques but in the use of the steps described to achieve the described results. Computer readable code which embodies the present invention is typically stored in permanent storage of some type, such as permanent storage of a workstation located at the program administrator's facility or his designated agents and licensees. In a client/server environment, such computer readable code may be stored with storage associated with a server. The computer readable code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying computer readable code on physical media and/or distributing computer readable code via networks are well known and will not be further discussed herein.

It will be understood that each element of the examples provided, and combinations of elements in the examples, can be implemented by general and/or special purpose hardware-based systems that perform the specified functions or steps, or by combinations of general and/or special-purpose hardware and computer instructions.

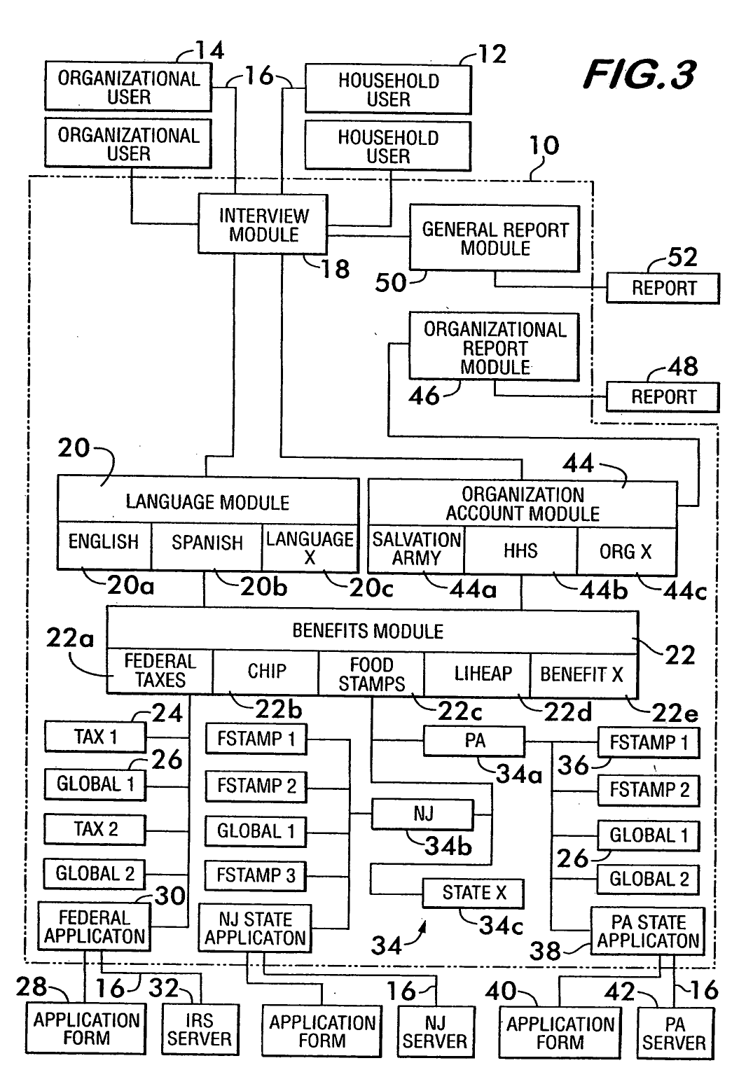

Program instructions may be provided to a processor to produce a machine, such that the instructions that execute on the processor create means for implementing the functions specified in the examples. The computer program instructions may be executed by a processor to cause a series of operational steps to be performed by the processor to produce a computer-implemented process such that the instructions that execute on the processor provide steps for implementing the functions specified in the examples. Accordingly, FIGS. 1-3 support combinations of means for performing the specified functions, combinations of steps for performing the specified functions, and program instruction means for performing the specified functions.

What is claimed is:

1. In a computer environment, a method of making a plurality of social benefits available to potential recipients, said method comprising the steps of:
providing a listing of said plurality of social benefits, each of said social benefits having eligibility requirements;
soliciting information from said potential recipients related to said eligibility requirements for said social benefits;
comparing said information to said eligibility requirements for said social benefits; and
predicting those social benefits of said plurality of social benefits for which said potential recipients qualify.

2. A method according to claim 1, further comprising the step of generating applications for said set of social benefits on behalf of said potential recipients.

3. A method according to claim 2, further comprising applying for said set of social benefits on behalf of said potential recipients.

4. A method according to claim 1, further comprising the step of soliciting said information directly from said potential recipients on an individual basis.

5. A method according to claim 1, further comprising the step of soliciting said information from said potential recipients as a group.

6. A method according to claim 1, further comprising soliciting said information from an organization with which said potential recipients are affiliated.

7. In a computer environment, a method of obtaining a plurality of desired social benefits for a potential recipient from among a plurality of benefit programs, said method comprising the steps of:
determining a set of said benefit programs providing the desired social benefits;
obtaining a first information set describing said potential recipient, said first information set comprising information commonly required by all of said benefit programs of said set to apply for said benefits;
obtaining a plurality of second information sets describing said potential recipient, each one of said second information sets comprising information specifically required by a corresponding one of said benefit programs of said set to apply for benefits;
comparing information in said first information set with requirements to obtain said desired benefits from all of said benefit programs of said set;
comparing information in each of said second information sets with requirements from said corresponding benefit program of said set to obtain said desired benefits; and
predicting the desired social benefits that the potential recipient is qualified to receive.

8. A method according to claim 7, further comprising applying for the desired social benefits on behalf of the potential recipient.

9. A method according to claim 8, wherein said applying step comprises applying to a plurality of organizations including the U.S. Federal Government, the governments of the states of the United States, a plurality of local governments, a plurality of private philanthropic organizations, a plurality of private commercial organizations and a plurality of private employers.

10. A method according to claim 2, wherein said applying step comprises applying for benefits from among programs including a food stamp program, a low income home energy assistance program, a prescription drug program, a medical service program, Federal and State Earned Income Tax Credit programs, a childrens' health insurance program and a voter registration program.

11. A method according to claim 7, comprising executing the steps of said method using computer readable code.

12. A method according to claim 11, wherein executing said steps is performed from a first computer system linked to a second computer system through a computer controlled communications network, said code being resident on said second computer.

13. A method according to claim 11, further comprising providing information to said code interactively by the steps of a user responding to prompting commands communicated to the user by said code.

14. A method according to claim 7, including the step of reviewing a catalog of available benefits.

15. Computer readable code stored on media for collecting and analyzing data describing the qualifications of a potential recipient of benefits from a plurality of benefit programs, said code comprising a plurality of benefit program modules, each capable of collecting data from the potential recipient necessary to apply for a particular benefit, analyzing said data against eligibility requirements for the particular benefit, calculating the degree of benefit for which the potential recipient qualifies, and providing the information necessary to apply for the benefit.

16. Computer readable code according to claim 15, further comprising an interview module for facilitating communications between the potential recipient and the benefit program modules.

17. Computer readable code according to claim 16, wherein said interview module further comprises a listing of the benefit programs supported by the code.

18. Computer readable code according to claim 15, further comprising a plurality of language modules providing a plurality of different languages for facilitating communication between said potential recipient and said code, a particular language being selectable from among said language modules by said potential recipient.

19. Computer readable code according to claim 15, wherein said benefit program modules comprise modules which collect data commonly required by a plurality of the benefit programs to apply for benefits.

20. Computer readable code according to claim 19, wherein said benefit program modules further comprise modules which collect data specifically required by one of the benefit programs.

21. Computer readable code according to claim 15, wherein said benefit program modules further comprise modules which are adapted to generate and transmit data to an authority administering a benefit program to formally apply for said social benefits.

22. A system for making a plurality of social benefits available to potential recipients., said system comprising:
a means for providing a listing of said plurality of social benefits, each of said social benefits having eligibility requirements;
a means for soliciting information from said potential recipients related to said eligibility requirements for said social benefits;
a means for comparing said information to said eligibility requirements for said social benefits; and
a means for predicting those social benefits of said plurality of social benefits for which said potential recipients qualify.

23. In a computer environment, a system for obtaining a plurality of desired social benefits for a potential recipient from among a plurality of benefit programs, said system comprising:
a means for determining a set of said benefit programs providing the desired social benefits;
a means for obtaining a first information set describing said potential recipient, said first information set comprising information commonly required by all of said benefit programs of said set to apply for said benefits;
a means for obtaining a plurality of second information sets describing said potential recipient, each one of said second information sets comprising information specifically required by a corresponding one of said benefit programs of said set to apply for benefits;
a means for comparing information in said first information set with requirements to obtain said desired benefits from all of said benefit programs of said set;
a means for comparing information in each of said second information sets with requirements from said corresponding benefit program of said set to obtain said desired benefits; and
a means for predicting the desired social benefits that the potential recipient is qualified to receive.
